(19) United States
(12) Patent Application Publication
(10) Pub. No.: US 2002/0125977 A1
(43) Pub. Date: Sep. 12, 2002

(54) Alternating pole magnetic detent

(76) Inventor: David VanZoest, Mesa, AZ (US)

Correspondence Address: DURASWITCH, 234 S. EXTENSION, SEC. 103, MESA, AZ, 85210, US

(21) Appl. No.: 09/803,567

(22) Filed: Mar. 9, 2001

(51) Int. Cl. H01F 7/02

(52) U.S. Cl. 335/306

(57) ABSTRACT

A magnetic detent for devices having at least one moving part. At least one bonded magnet with substantially alternating North and South poles is used which interacts with a magnetic material or another magnet. Where more than one magnet is used, one is located on a stationary assembly and another is located on a moveable assembly. The detent may provide tactile feel for manually operated devices such as rotating and sliding electrical switches including magnetically actuated switches. Bonded magnet such as bonded sheet magnet may be used for one or more magnets. Magnetic poles may be oriented so that as the device is operated, either like poles or opposite poles line up at the same time. With some embodiments, the magnets are allowed to contact when opposite poles line up. With other embodiments, an air gap is maintained between the magnets.

### BACKGROUND OF THE INVENTION

1. Field of the Invention

This invention relates generally to detent systems for devices having at least one moving part.

2. Description of the Related Art

In the design and construction of devices having at least one moving part, there are many situations where it is necessary or desirable to provide a system or feature to facilitate the stopping of the moving part or to assist the moving part in maintaining a stopped position at one or more particular positions. Such a system or feature is referred to herein as a detent. In situations where the device is manually operated, detents may alternatively, or in addition, provide feedback or “feel” to the operator assuring the operator that the moving part has moved, is moving, or has reached a desired location. In the prior art, detents have been constructed in numerous ways, including the use of a spring loaded metal ball against a plastic detent cam. However, whenever a detent employs a mechanical interface, wear and breakage often become limiting factors in the life of the entire device.

Detents have been used in mechanical devices including linkages and valves, and in electromechanical devices including switches. The term “switch”, as used herein, is meant to include any electromechanical device capable of changing an electrical circuit, including a potentiometer or encoder. Many switches utilize a detent offering positive tactile feedback to the operator that the switch position has changed. Magnets have been used in switches, including to provide detents and tactile feedback. Switches of this general type are shown and described in U.S. Pat. Nos. 5,523,730, 5,666,096 and 5,867,082. However, it is advantageous to expand the applications of such switches even further.

### SUMMARY OF THE INVENTION

It is an object of the present invention to provide detent systems for devices having at least one moving part. Further objects and features of various embodiments of the present invention are that they be suitable for use in rotary or sliding switches and that they be durable enough so as to not limit the life of the switch. Further objects and features of various embodiments of the present invention are that they offer the tactile feedback users expect when manipulating the position of a switch. It is desirable to avoid tactile feedback that is annoying to the user, or that makes the entire device utilizing the detent appear to be cheap or unreliable. Accordingly, one object of various embodiments of the present invention is to provide a detent that will maintain the same tactile feedback for the life of a very durable, reliable, and long-lasting switch.

In furtherance of these objects and desired features, embodiments of the present invention provide a detent utilizing the attractive and repulsive forces of permanent magnets that can provide a virtually wear-proof detent that could survive for the life of a high-quality magnetically actuated switch or other device. In various embodiments, this invention provides a magnetic detent with at least one portion of bonded sheet magnet with substantially alternating North and South poles, and at least one separate magnet adjacent to the bonded sheet magnet, wherein the separate magnet is movable across a width of the bonded sheet magnet and the orientation of the magnetic poles of the separate magnet are in alignment with the poles of the bonded sheet magnet so that there are magnetically attractive and repulsive positions. The separate magnet may be rigidly held a fixed distance from the sheet magnet or loosely held adjacent the sheet magnet, allowing the separate magnet to contact the sheet magnet when there is an attractive magnetic force, and allowing the separate magnet to move away from the sheet magnet when there is a repulsive magnetic force. The bonded sheet magnet or the separate magnet may be coated with a protective layer configured to reduce wear and friction between the surface of the bonded sheet magnets and the surface of the separate magnet. The bonded sheet magnet may be flexible. The separate magnet may also be comprised of at least one portion of bonded sheet magnet, and may also be flexible. The bonded sheet magnet may having alternating North and South poles that are between 1 millimeter (mm) and 5 mm apart. Further, the bonded sheet magnet may be looped back onto itself, forming a cylinder. The separate magnet may be rotationally moveable and may have the same number of degrees of arc of rotation per magnetic pole as the sheet magnet.

This invention also provides a magnetic detent system for a device having at least one moving part, wherein the system has a bonded magnet with a plurality of substantially alternating North and South poles, a magnetic material, and a structure configured to allow the magnetic material to undergo movement relative to the bonded magnet through its magnetic field. The magnet may be one piece of material, and may be bonded magnet. The magnetic material may be a permanent magnet, and may also be one or more portions of bonded magnet. The movement may be rotational, and may have substantially the same number of degrees of arc of rotation per magnetic pole. On the other hand, the movement may be substantially linear, and the two magnets may have the same magnetic pole spacing. This invention may include the device, which may be manually operated, and may provide tactile feel when the device is operated. The device may have electrical contacts, and may be an electrical switch, including a magnetically actuated switch. The device may also be an encoder, or even a rheostat. Further, the device may be rotational, and the two magnets may have substantially the same number of degrees of arc of rotation per magnetic pole. Alternatively, the magnetic material may be made of a plurality of portions of bonded magnet each with substantially the same magnetic pole spacing.

This invention further provides a manually operated device having a magnetic detent, the device having a structure with a stationary assembly and a moveable assembly, each with a magnet, at least one magnet having a plurality of alternating North and South poles, wherein the structure is configured to allow the moveable magnet to move adjacent to the stationary magnet, and the device is configured so that the interaction of the stationary magnet and the moveable magnet provides tactile feel when the device is operated. In one embodiment, both the stationary magnet and the moveable magnet have a plurality of alternating North and South poles. The orientation of the North and South poles of the moveable magnet may be in alignment with the North and South poles of the stationary magnet so that at a plurality of locations of the moveable assembly, substantially all of the North poles of the moveable magnet substantially line up with substantially all of the South poles of the stationary magnet and substantially all of the South poles of the moveable magnet substantially line up with substantially all of the North poles of the stationary magnet. The device may be an electrical switch, or even a magnetically actuated electrical switch. The moveable assembly may be configured to rotate, and the stationary magnet may be essentially cylindrical. The device may be configured so that the moveable magnet makes contact with the stationary magnet when poles of the moveable magnet line up with opposite poles of the stationary magnet. The moveable assembly may have a plurality of moveable magnets, which may be bonded sheet magnet. In addition, the alternating North and South poles may be 1 mm to 5 mm apart, and the stationary magnet may be less than 1 mm thick.

### BRIEF DESCRIPTION OF THE DRAWINGS

The present invention is illustrated by way of example and not limitation in the accompanying figures, in which like reference numbers indicate similar elements, and in which:

FIG. 1 is a plan view of bonded sheet magnet aligned with a movable magnet according to an exemplary embodiment of the present invention;

FIG. 2 is a cross-sectional view taken along line 10-10 of FIG. 1;

FIGS. 3-5 are cross-sectional views similar to FIG. 2 showing alternate positions of the moveable magnet according to various exemplary embodiments of the present invention;

FIG. 6 is a side elevation view of a magnetically actuated rotary switch with a magnetic detent according to an exemplary embodiment of the present invention;

FIG. 7 is a section view taken along line 12-12 of FIG. 6;

FIG. 8 is a plan view of a slider switch with a magnetic detent according to an exemplary embodiment of the present invention;

FIG. 9 is a section taken along line 30-30 of FIG. 8.

### DETAILED DESCRIPTION OF THE INVENTION

The present invention provides a magnetic detent or detent system generally for devices having at least one moving part. The present invention may use a set of opposing force permanent magnets typically mounted to both fixed and moving parts of the device. Alternatively, a permanent magnet and a magnetic material may be used. In an exemplary embodiment, a detent using bonded magnetic sheet material that is typically magnetized with alternating North and South poles makes the present invention highly adaptable. Combinations of magnets can be incorporated into an assembly to provide a compact, reliable and durable detent function. These magnetic detents preferably offer the tactile feel an operator desires with the reliability and virtually unlimited life expectancy of a permanent magnet.

A magnet such as a permanent magnet produces a magnetic field, external to itself, that attracts, inter alia, magnetic materials, including ferromagnetic materials. Every permanent magnet has at least one North pole and at least one South pole. The North pole of any given permanent magnet is attracted to the South pole of every other magnet brought within range of the magnetic fields of the permanent magnet. By contrast, the South pole of any given permanent magnet is repelled from the South pole of every other magnet. In general, opposing poles of magnets generate an attractive force, but like poles of magnets generate a repelling force. This force is related to the magnetic strength of the materials, the number and size of magnetic poles, and the distance of separation. If magnets are free to move relative to each other, they will naturally pull each other toward the position of net maximum attractive force. Similarly, magnets will push each other away from any position of net repulsive force.

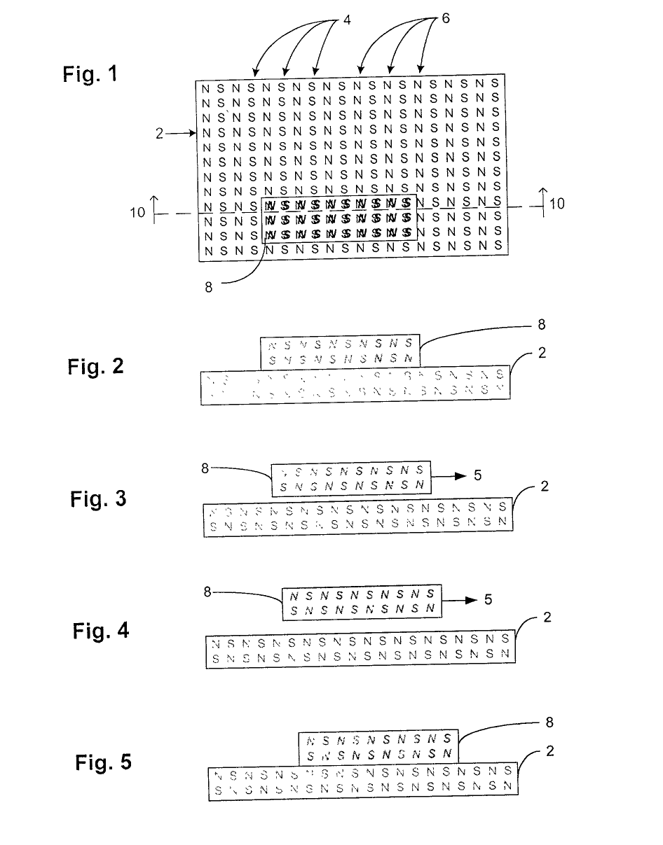

Iron, steel, and various metal alloys or magnetic materials are frequently given the qualities of a magnet artificially. Bonded sheet magnets, commonly used to make refrigerator magnets, are one type of artificial permanent magnet. As used herein, “bonded” means that there is a bonding agent, adhesive, or binder of some sort, like polyethelene, that holds together the magnetic material. “Magnetic material” is generally anything that is affected by a magnet, including, as an example, ferrite. In a bonded magnet, the magnetic material typically has the form of a powder, and is held together by the binder. Bonded sheet magnets are commonly manufactured into flexible sheets typically with alternating magnetic poles that run the length of the sheet. The sheets may be formed, for example, by rolling or pressing into a thin layer. Bonded sheet magnet as may be used in the present invention may be less than 1 mm thick. Once formed, bonded magnets, including bonded sheet magnets, may be cut into various sized pieces or portions, which may have as few as one North pole and one South pole, or may have a plurality of North and South poles, typically alternating. As an example, FIGS. 1-5 illustrate a bonded sheet magnet 2 that has 2 mm widths of North pole peaks 6 running the length of the sheet, all adjacent 2 mm widths of South pole valleys 4. This typically forms a N-S-N-S-N-S-N wave of magnetic peaks 6 and valleys 4 across the width of the surface of bonded sheet magnet 2. In other words, the North and South poles are alternating.

If bonded sheet magnet 2 is affixed flat on a table, as an illustrative example, and then a separate movable magnet 8 is moved adjacent to and, for instance, across the width of bonded sheet magnet 2, the movable magnet 8 will generally be pushed up where the North poles of moveable magnet 8 line up with the North poles 6 of bonded sheet magnet 2 and the South poles of moveable magnet 8 line up with the South poles 4 of bonded sheet magnet 2. See FIG. 4. In contrast, the movable magnet 8 will generally be pulled down where the South poles of moveable magnet 8 line up with the North poles 6 of bonded sheet magnet 2 and the North poles of moveable magnet 8 line up with the South poles 4 of bonded sheet magnet 2. See FIG. 2. The peaks and valleys, for instance, North poles 6 and South poles 4, don't need to be 2 mm apart or wide. They can be 1 mm wide, or any other width or distance apart that is appropriate for the particular purpose the detent is intended. Bonded magnets may also be extruded into a variety of shapes including having a bar-like or rectangular cross section.

FIGS. 1 and 2 illustrate the movable magnet 8 in an attractive position on the adjacent bonded sheet magnet 2. FIG. 3 illustrates that as an external force 5 is applied to the movable magnet 8 in the direction leading to the right side of the drawing, like poles come into alignment and push the movable magnet away from the face of the bonded sheet magnet. FIG. 4 illustrates that the magnetic repulsion is at a maximum when the like poles on the bonded sheet magnet and movable magnet line up or are facing each other. FIG. 5 shows that if the external force 5 is removed from the movable magnet, it is pulled into alignment with opposing poles on the bonded sheet magnet. This is typically a rapid pull that causes the moveable magnet 8 to abruptly meet with the surface of the sheet magnet 2, which may produce a slapping sound. If an external force 5 rapidly slides the movable magnet 8 across many peaks and valleys of the bonded sheet magnet 2, for instance, across a width of bonded sheet magnet 2, the movable magnet 8 will typically slap the sheet magnet at opposing poles, then jump and float over the sheet magnet 2 at like poles. In some embodiments of the present invention, for instance where one magnet is loosely held adjacent the other magnet, this jump/slap/jump/slap that the movable magnet 8 experiences provides the distinct “clicking” feel that is desired in a detent.

However, the jump/slap function is not found in some embodiments of the present invention. For maximum life of the detent, the movable magnet 8 may be prevented from physically touching and wearing the bonded sheet magnet 2. In other words, the separate or moveable magnet may be rigidly held a fixed distance from the stationary or sheet magnet, generally close enough that the magnetic fields interact. Thus, an air gap exists between magnets 8 and 2. The tactile feedback may still exist, or even be strong, but there will not be a wear problem between the movable magnet 8 and the bonded sheet magnet 2. If the slapping sound is desired, a thin, low friction material may be used between the magnets (8 and 2), such as a coating or protective layer on the magnets (8 and 2) that will allow them to slide against each other with minimal friction and wear. In many embodiments it is best to use a movable magnet 8 that has approximately the same magnetic field strength as the bonded sheet magnet 2. This is because a stronger magnet may have the ability to permanently distort the weaker magnet's field and change the characteristics of the detent.

The movable magnet 8 may have multiple alternating poles that align with the alternating poles (4 and 6) of the bonded sheet magnet 2. FIGS. 1-5 illustrate, as an exemplary embodiment, a separate piece of bonded sheet magnet being used as the movable magnet 8. Because of the orientation of the poles on the bonded sheet magnet 2, in many embodiments the movable magnet 8 is aligned with the bonded sheet magnet 2. When aligned as shown so that the orientation of the magnetic poles of the separate magnet are in alignment with the poles of the bonded sheet magnet, there are magnetically attractive and repulsive positions and the magnets are most strongly attracted to each other or repulsed from each other.

Bonded magnet, including bonded sheet magnet, may be manufactured so that it is relatively rigid or relatively flexible, depending on the bonding agent used to make the sheet. Examples include flexible bonded ferrite magnet and flexible bonded NdFeB magnet. Flexible bonded magnet may be contoured onto an existing shape, such as a rotary knob. If a width of sheet magnet is looped back onto itself forming a cylinder, as magnet 8 is in FIG. 7, and then another width of the same bonded magnet is formed around it, the magnetic poles will typically not properly align because the diameters are different. FIG. 7 shows that if a width of bonded sheet magnet is used as the movable magnet 8, then the fixed bonded sheet magnet 2 may, in an exemplary embodiment, be formed from multiple portions of material or have breaks 14 that allow the magnetic poles to properly align and maximize the detent strength. In other words, there may be a plurality of moveable magnets, which may each be formed from bonded magnet. It is understood that there are many possible variations of alignment of the bonded magnet with the movable magnet. In addition, in various embodiments of the present invention, either part, or both, may actually move. Which part is called movable is a matter of perspective.

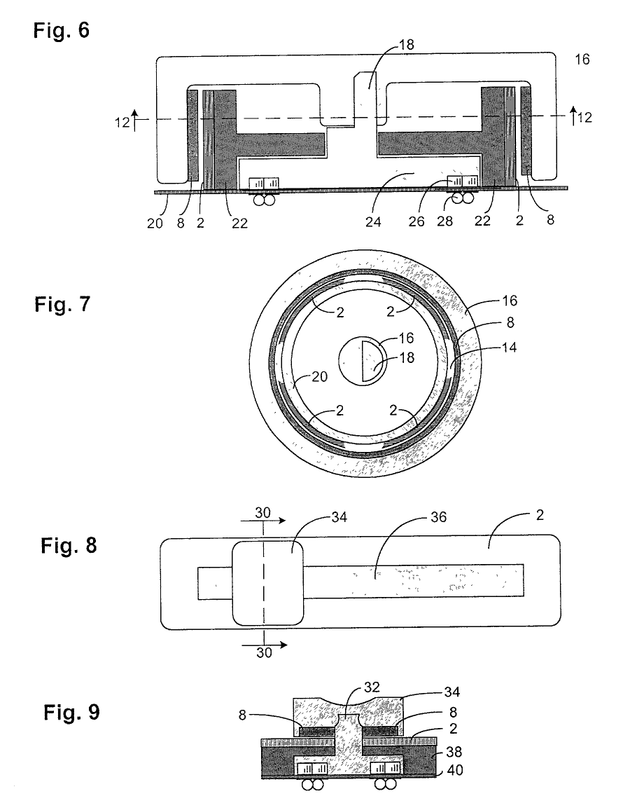

The present invention magnetic detent may be used on a variety of devices having at least one moving part, including devices that are manually operated, for instance by a human hand. The magnetic detent of the present invention may provide tactile feel when a device equipped with a magnetic detent is manually operated. The present invention may be used on devices that have electrical contacts such as electrical switches including magnetically actuated switches, encoders, and rheostats. FIGS. 6 & 7 illustrate an exemplary embodiment of the present invention featuring a magnetically actuated rotary switch of the twin-ball type with a magnetic detent. A magnetically actuated switch, like the ones shown and described in U.S. Pat. No. 5,867,082, is preferred in many applications because of its superior durability and reliability. However, the magnetic detent of the present invention could be similarly utilized in a conventional switch assembly.

In FIGS. 6 & 7, the rotary switch typically has a knob 16 mounted to a shaft 18. Knob 18 would typically be sized so as to be practical for operation by a person. Knob 18 may have a diameter, for example, of about 2 centimeters (cm). In the embodiment shown, around an inside diameter of knob 16 is a width of bonded sheet magnet 8. Shaft 18 may be fixed to, or part of, a plate 24 that carries coupler magnets 26. The coupler magnets 26 typically magnetically attract and carry conductive armatures 28. The armatures 28, coupler magnets 26, plate 24, shaft 18, knob 16, and bonded sheet magnet 8 are typically rotationally movable as a unit or assembly. Plate 24 is typically confined to rotational movement inside the mounting bracket 22, which, in the embodiment shown, is permanently attached to a carrier layer 20. In the embodiment illustrated, on the outer diameter of mounting bracket 22 is another width of bonded sheet magnet 2 that in some embodiments is discontinuous or formed in multiple portions so that the magnetic poles will properly align with the bonded sheet magnet 8 on knob 16. As shown, magnet 2 is adjacent to magnet 8. Either magnet, or both, may be flexible as described above.

Alignment of the movable and fixed magnet may become problematic for smaller diameter knobs. In such cases, the fixed magnet may be a width of bonded sheet magnet and the movable magnet may be a series of individual magnets mounted for movement adjacent an inside or outside diameter of the bonded sheet magnet. Again, either magnet or set of magnets may actually move, and which magnet is movable is a matter of perspective.

In an alternate embodiment, the cylinder of discontinuous bonded sheet magnet 2 in FIG. 7 may be continuous, but magnetized so that the poles are slightly closer together. The bonded sheet magnet is typically magnetized in ways known to people skilled in the art, typically after the bonded sheet is manufactured. By having the poles closer together on the inside diameter bonded sheet magnet, alignment of poles, as in FIGS. 1-5, is possible. If the specially manufactured bonded sheet magnet is used, the outside width of bonded sheet magnet may have the same total number of magnetic poles as the inside width of bonded sheet magnet. In other words, both cylinders of bonded sheet magnet may have the same number of degrees of arc of rotation per magnetic pole. In other embodiments, the stationary and rotating magnets may have a different number of poles. For instance, the number of poles on one magnet may be a multiple of the number of poles on the other magnet. Both sets of poles may be evenly spaced around the circumference.

FIGS. 8 & 9 illustrate, as an example, a magnetically actuated slider switch with a magnetic detent according to the present invention. For instance, a magnetically actuated switch, like the ones shown and described in U.S. Pat. No. 5,867,082, may be used. The magnetic detent of the present invention could be similarly utilized in a conventional slider switch assembly.

In the exemplary embodiment illustrated in FIGS. 8 & 9, the slider switch has a knob 34 that attaches to a shaft 32, for instance, with a snap fit. Knob 34 may have a width, for example, of about 2 cm, and may slide a distance of 5 to 10 cm. The shaft 32 may be attached to a plate holding coupler magnets that carry the armatures against the carrier layer 40 in a similar fashion to what is illustrated in FIG. 6. The shaft 32 typically travels in a linear path through a channel 36. The movable knob 34 may have bonded sheet magnet 8 attached to its underside. The armatures, coupler magnets, plate, shaft 32, knob 34, and bonded sheet magnet 8 are typically linearly movable as a unit or assembly. The movable magnet 8 is adjacent to bonded sheet magnet 2 that is typically fixed to the mounting bracket 38. The mounting bracket 38 is typically fixed to the carrier layer 40. As the knob 34 is moved back and forth through the channel 36, a tactile detent may be felt as the fixed bonded sheet magnet 2 attracts and repels the movable bonded sheet magnet 8 on the underside of the knob 34. Either magnet, or both may be flexible, as described above. In embodiments where the moveable magnet 8 has a plurality of poles adjacent to bonded sheet magnet 2, moveable magnet 8 and bonded sheet magnet 2 may have substantially the same magnetic pole spacing, for instance, as shown in FIGS. 1-5.

While a preferred form of the invention has been shown and described, it will be realized that alterations and modifications may be made thereto without departing from the scope of the following claims. For example, the movable magnet could be only partially attached to the knob, allowing it to flap between the knob and the fixed bonded sheet magnet. A thin laminate could be placed over the bonded sheet magnet to protect it against wear. For the slider switch, a thin laminate could be laid over the fixed bonded sheet magnet and additionally have graphics printed on the surface. Accordingly, the specification and figures are to be regarded in an illustrative rather than a restrictive sense, and all such modifications are intended to be included within the scope of the present invention. In addition, benefits, other advantages, and solutions to problems have been described above with regard to specific embodiments. However, any benefit, advantage, or solution to occur or become more pronounced are not to be construed as a critical, required, or essential feature or element of any or all of the claims.

What is claimed is:

1. A magnetic detent comprising:
at least one portion of bonded sheet magnet having substantially alternating North and South poles;
at least one separate magnet adjacent said bonded sheet magnet, the separate magnet having at least one North pole and at least one South pole;
the separate magnet being movable across a width of the bonded sheet magnet; and
the orientation of the magnetic poles of the separate magnet being in alignment with the poles of the bonded sheet magnet so that there are magnetically attractive and repulsive positions.

2. The magnetic detent of claim 1, the separate magnet being rigidly held a fixed distance from the sheet magnet.

3. The magnetic detent of claim 1, the separate magnet being loosely held adjacent the sheet magnet, allowing the separate magnet to contact the sheet magnet when there is an attractive magnetic force, and allowing the separate magnet to move away from the sheet magnet when there is a repulsive magnetic force.

4. The magnetic detent of claim 3, at least one of the bonded sheet magnet and the separate magnet being coated with a protective layer configured to reduce wear and friction between the surface of the bonded sheet magnets and the surface of the separate magnet.

5. The magnetic detent of claim 1, the bonded sheet magnet being flexible.

6. The magnetic detent of claim 1, the separate magnet being comprised of at least one portion of bonded sheet magnet.

7. The magnetic detent of claim 6, the separate magnet being flexible.

8. The magnetic detent of claim 6, the bonded sheet magnet having alternating North and South poles, said North and South poles being between 1 mm and 5 mm apart.

9. The magnetic detent of claim 1, the bonded sheet magnet being looped back onto itself, substantially forming a cylinder.

10. The magnetic detent of claim 9, the separate magnet being rotationally moveable, the separate magnet comprising at least one portion of bonded sheet magnet.

11. The magnetic detent of claim 9, the bonded sheet magnet and the separate magnet having substantially the same number of degrees of arc of rotation per magnetic pole.

12. A magnetic detent system for a device having at least one moving part, said detent system comprising:
a bonded magnet comprising a plurality of substantially alternating North and South poles having magnetic fields;
a magnetic material;
a structure configured to allow said magnetic material to undergo movement relative to said bonded magnet substantially through said magnetic fields.

13. The magnetic detent system of claim 12, said bonded magnet consisting of substantially one piece of material.

14. The magnetic detent system of claim 12, said magnetic material being a permanent magnet.

15. The magnetic detent system of claim 14, said magnetic material comprising multiple portions of bonded magnet.

16. The magnetic detent system of claim 12, said movement being rotational.

17. The magnetic detent system of claim 16, said magnetic material comprising permanent magnet, said bonded magnet and said magnetic material having substantially the same number of degrees of arc of rotation per magnetic pole, said magnetic material comprising bonded magnet.

18. The magnetic detent system of claim 12, said movement being substantially linear.

19. The magnetic detent system of claim 18, said magnetic material comprising permanent magnet, said bonded magnet and said magnetic material having substantially the same magnetic pole spacing, said magnetic material comprising bonded magnet.

20. The magnetic detent system of claim 12 further comprising the device.

21. The magnetic detent system of claim 20, said device being manually operated, said bonded magnet and said magnetic material providing tactile feel when said device is operated.

22. The magnetic detent system of claim 20, said device comprising electrical contacts.

23. The magnetic detent system of claim 20, said device being an electrical switch.

24. The magnetic detent system of claim 23, said magnetic material comprising permanent magnet, said bonded magnet and said magnetic material having substantially the same number of degrees of arc of rotation per magnetic pole, said magnetic material comprising bonded magnet.

25. The magnetic detent system of claim 24, said magnetic material comprising a plurality of portions of bonded magnet.

26. The magnetic detent system of claim 23, said device being a magnetically actuated switch.

27. The magnetic detent system of claim 20, said device being an encoder.

28. The magnetic detent system of claim 20, said device being a rheostat.

29. A manually operated device having at least one magnetic detent, said device comprising:
a structure comprising a stationary assembly having a stationary magnet and a moveable assembly having a moveable magnet;
at least one of said stationary magnet and said moveable magnet comprising bonded magnet having a plurality of alternating North and South poles having magnetic fields;
said structure being configured to allow said moveable magnet to move adjacent to said stationary magnet; and
said device being configured so that the interaction of said stationary magnet and said moveable magnet provides tactile feel when said device is operated.

30. The manually operated device of claim 29, both of said stationary magnet and said moveable magnet comprising bonded magnet having a plurality of alternating North and South poles having magnetic fields.

31. The manually operated device of claim 30, the orientation of the North and South poles of the moveable magnet being in alignment with the North and South poles of the stationary magnet so that at a plurality of locations of said moveable assembly, substantially all of the North poles of said moveable magnet substantially line up with substantially all of the South poles of said stationary magnet and substantially all of the South poles of said moveable magnet substantially line up with substantially all of the North poles of said stationary magnet.

32. The manually operated device of claim 29, said device being an electrical switch.

33. The manually operated device of claim 29, said device being a magnetically actuated electrical switch.

34. The manually operated device of claim 29, said moveable assembly being configured to rotate.

35. The manually operated device of claim 29, said moveable assembly being configured to rotate, said stationary magnet being essentially cylindrical.

36. The manually operated device of claim 29, said device being configured so that said moveable magnet makes contact with said stationary magnet when poles of said moveable magnet lines up with opposite poles of said stationary magnet.

37. The manually operated device of claim 29, said moveable assembly comprising a plurality of moveable magnets.

38. The manually operated device of claim 29 said stationary magnet comprising bonded sheet magnet, said moveable assembly comprising a plurality of moveable magnets, said moveable magnets comprising bonded sheet magnet.

39. The manually operated device of claim 29, said alternating North and South poles being 1 mm to 5 mm apart.

40. The manually operated device of claim 29, said stationary magnet being less than 1 mm thick.

41. The manually operated device of claim 29, both of said stationary magnet and said moveable magnet comprising a plurality of alternating North and South poles having magnetic fields, the orientation of the North and South poles of the moveable magnet being in alignment with the North and South poles of the stationary magnet so that at a plurality of locations of said moveable assembly, substantially all of the North poles of said moveable magnet substantially line up with substantially all of the South poles of said stationary magnet and substantially all of the South poles of said moveable magnet substantially line up with substantially all of the North poles of said stationary magnet, said device being an electrical switch, said moveable assembly being configured to rotate, said stationary magnet being essentially cylindrical, said stationary magnet comprising bonded sheet magnet, and said moveable magnets comprising bonded sheet magnet.
